(19) United States
(12) Patent Application Publication
(10) Pub. No.: US 2008/0177832 A1
(43) Pub. Date: Jul. 24, 2008

(54) SYSTEM AND METHOD FOR ACCELERATING ACTION NETWORKS

(76) Inventors: Eran Reshef, Tel Aviv (IL); Amir Hirsh, Tel Aviv (IL)

Correspondence Address: DREIER LLP, 499 PARK AVE, NEW YORK, NY, 10022, US

(21) Appl. No.: 12/017,640

(22) Filed: Jan. 22, 2008

Related U.S. Application Data
(60) Provisional application No. 60/886,042, filed on Jan. 22, 2007.

(51) Int. Cl. G06F 15/16

(52) U.S. Cl. 709/204

(57) ABSTRACT

A method and system for accelerating a response rate for action networks, wherein the action networks provide calls for actions (CFAs) to users, includes preparing a CFA for submission to the users. The method and system determines user contact information for the various users, which indicates if the CFA is transmitted via either a slow communication mode (SCM) technique or a rapid communication mode (RCM) technique. For users having contact information indicating transmission via the SCM technique, the method and system provides a conversion request (CR), which invites the user to convert from SCM to RCM for receiving CFAs. The system and method transmits the CFAs to the user via the designated communication mode techniques. The user may accept the CR, such that the system and method receives the response and updates the user contact information from the SCM technique to the RCM technique.

### PRIORITY CLAIM

This application is claims the benefit of U.S. Provisional Application No. 60/886,042, entitled “SYSTEM AND METHOD FOR ACCELERATING ACTION NETWORKS,” filed on Jan. 22, 2007, which is hereby incorporated by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present invention is directed to computer networks used for contacting users for performing particular actions, and more particularly to a system and method for accelerating action networks using the computer networks.

### BACKGROUND OF THE INVENTION

Action networks are groups of activists working together to achieve a common goal. An action network has a coordinator (e.g., a not-for-profit organization) which frequently sends calls-for-action (CFAs) with activists, asking them to take specific actions (e.g., write to a Senator) to advance the action network's goal (e.g., protect civil rights).

Today's action networks rely on email to communicate with the activists. However, email is far from being an ideal communication platform. Spam filters sometimes prevent calls-for-action from reaching activists. Inbox clutter and infrequent checking of email make activists respond slowly to calls-for-action they do receive.

Many calls-for-action are timely in their nature, and lose their impact if an activist does not act within a few hours. Furthermore, coordinating the timing of the act can greatly enhance its impact. For example, sending 100 faxes to a Senator over one hour is likely to make more impact then sending the same number of faxes over a week.

While there are more rapid ways to communicate than email, such as instant messaging, action networks already have large electronic mailing list. Simply scraping the existing mail list is not a viable option. There is a clear need for a graceful migration path from email to more rapid communication methods that will accelerate the response rate of existing action networks.

### BRIEF SUMMARY OF THE INVENTION

A method and system for accelerating a response rate for action networks, wherein the action networks provide calls for actions (CFAs) to users (also generally referred to as activists) includes preparing a CFA for submission to the users. These users are in communication using any number of available computing communication networks. The method and system thereupon determines user contact information for the various users, where the contact information indicates if the CFA is to be transmitted via either a slow communication mode (SCM) technique or a rapid communication mode (RCM) technique. By way of example, a SCM technique may be electronic mail and a RCM technique may be an instant message, really simple syndication (RSS) feed, a short messaging system (SMS) message or any other suitable form of rapid communication.

For each of the users having contact information indicating transmission via the SCM technique, the method and system provides a conversion request (CR) to the user, where the CR invites the user to convert from the SCM technique to the RCM technique for receiving CFAs. A CR can be text (e.g., “send SMS from your mobile to this number to start receiving calls-for-action via your mobile”), an image or any other format useful for persuading activists to switch to RCM. A CR can also include a web link, or other automation mechanism, to ease the transition to RCM (e.g., “click here to automatically start receiving calls-for-actions on your MSN Messenger”). The system and method transmits the CFAs to the user via the designated communication mode techniques, the SCM technique for users having SCM-identified contact information and the RCM technique for users having RCM-identified contact information.

The user receiving the CFAs via the SCM technique may thereupon review the CR, which requests to convert the communication from the SCM technique to the RCM technique. The user may accept the CR, such that the system and method receives the response and updates the user contact information from the SCM technique to the RCM technique.

Other aspects would become apparent to those skilled in the relevant art(s) in view of the teachings of the present disclosure. Additional aspects of the present invention would be apparent in view of the description that follows.

### BRIEF DESCRIPTION OF THE DRAWINGS

The foregoing and other aspects of the invention will become more apparent from the following description of illustrative embodiments thereof and the accompanying drawings, which illustrate, by way of example, the principles of the invention. In the drawings:

FIG. 1 illustrates one embodiment of an accelerated action-network including a system for accelerating a response rate;

FIG. 2 illustrates the components of a system for accelerating action-networks and its internal data flow;

FIG. 3 illustrates a screen shot of an exemplary CR; and

FIG. 4 illustrates a flowchart of the steps of one embodiment of a method for accelerating a response rate for action networks.

### DETAILED DESCRIPTION OF ILLUSTRATIVE EMBODIMENTS

The present invention will now be described in detail with reference to the drawings, which are provided as illustrative examples of the invention so as to enable those skilled in the relevant art(s) to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

Overview of an Accelerated Action-Network

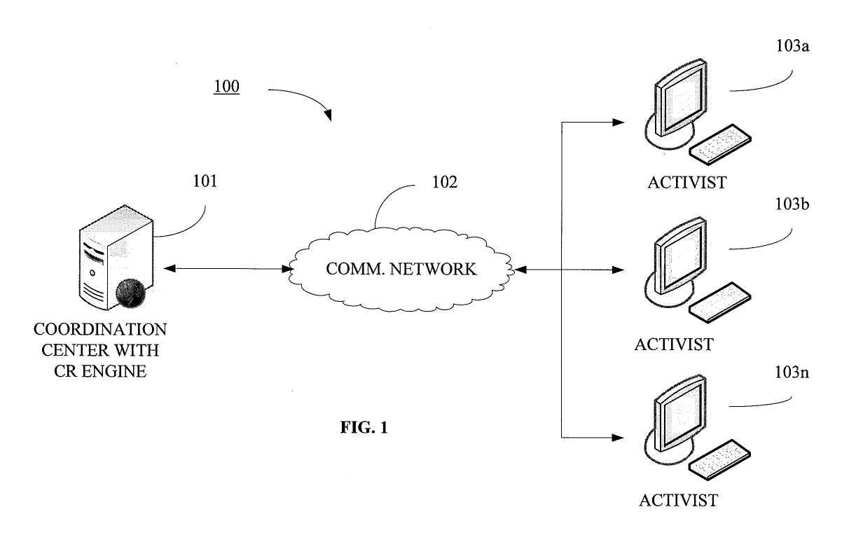

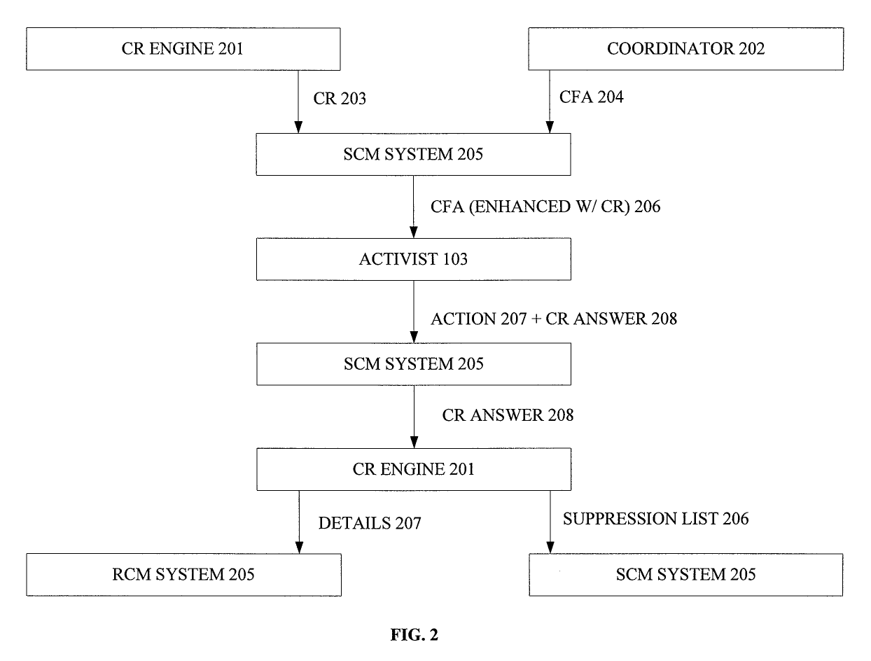

FIG. 1 illustrates one embodiment of an accelerated action network 100 that includes a coordination center 101 (enhanced with a CR Engine 201, as described in further detail below with respect to FIG. 2), a communication network 102 and a plurality of activists 103a-103n (collectively referred to as 103). The communication network 102 may be any suitable type of network for communication, such as the Internet, but may also include additional communication techniques such as wireless transmission techniques, such as for example a Short Message Service (SMS).

Activists 103a-103n may use a wired and/or wireless personal computer, personal digital assistant (PDA), enhanced telephone, personal television, or other data processing device linked to communications network 102 to communicate with the coordination center 101 for receiving CFAs. In typical operation, the activists 103 use the computing devices for normal operations, for example if the device is a personal computer, the user/activist can visit various web pages on the Internet, check email and other standard operations. In another example, if the device is a PDA or enhanced telephone, the user may conduct various types of communication activities, such as making calls, sending emails, by way of example.

Within the coordination center 101 are processing operations, in response to executable instructions, for providing the method for accelerating a response rate for action networks that provide CFAs. In one embodiment, the executable instructions may be stored in a computer readable medium such that a reading device reads the instructions from the medium for receipt and processing of executable instructions by the coordination center 101.

The coordination center 101, when generating CFAs, may operate in accordance with known techniques. For example, one technique for generating CFAs may include a coordinator or other type of administrator entering CFA-based information. Other techniques can include automated operations set to run based on the recognition of specific events or in response to a user-generated request. Regardless of the specific techniques associated with the generation of the CFA, the coordination center 101 further includes the processing ability to accelerate a response rate, where the response rate includes the speed at which the users or activists 103 receive the CFAs and can thereby accordingly perform actions for which they have been called.

In the system 100, the coordinator center 101 generates the CFA with the CR included, as described in greater detail below. For the activists 103 being communicated with using the slow communication mode (SCM) technique, the coordination center 101 includes the CR. For activists being communicated with using the rapid communication mode (RCM) technique, the coordination center 101 transmits the CFA in a typical fashion.

As understood, and accordingly not further described herein, the activists 103 receive the CFAs and can thereupon perform the suitable actions. For example, if the action of the CFA is to email an elected representative, the activist 103 may then choose to prepare and send the email. Additional embodiments can include additional features usable for tracking the effectiveness of the CFAs themselves, whereas the coordination center 101 herein accelerates the response rate by detecting activists using the SCM technique and attempting to convert them to the RCM technique.

FIG. 2 illustrates an embodiment of an accelerated action-network 100. However, the present invention is not implicitly or explicitly limited to such an embodiment, and various alternative models and organizations would become apparent to those skilled in the relevant art(s) after being taught by the present example. The components of FIG. 2 can be implemented using a combination of computer hardware, firmware, and software, using engineering design techniques and network protocols that are guided by the principles of the present invention as would become apparent from the detailed descriptions herein. For example, all components can be implemented as software components running on top of standard personal computers running the Windows® operating systems available from Microsoft Corporation (Redmond, Wash.).

The components of the coordination center 100 include a conversion request (CR) Engine 201, a SCM system 205, and an RCM system 215. The SCM system 205 may be any suitable type of communication system that operates in a slow communication mode, where slow is relative to the speed of the rapid communication system. By way of example, a SCM technique may include an electronic mail that uses one of a number of electronic mail applications, the mailings must be generated, addressed and then transmitted using existing transmission techniques. The users must then have a device present that includes the ability to run an application reader/viewer. Moreover, electronic mail transmissions are typically routed through various mail servers, which can additionally slow down or otherwise delay the speed of delivery between when the electronic mail is generated/sent and received/read by the intended recipient. In a further example, the RCM system 215 provides for rapid communication, such as for example instant messaging (IM), a really simple syndication (RSS) feed, a short messaging service (SMS) system, and desktop alerts that can run on a user's desktop processing environment.

Coordinator 202 is the person in charge of creating calls-for-action (CFAs) and entering those in the SCM system 205. SCM System 205 is an external system able to communicate via SCM. Such system usually includes a web site and a bulk email sending software that asks activists to visit the web site in order to take action.

CR Engine 201 generates Conversion Request (CR) 203 for activists to convert to a RCM before, during or after completing CFA 204. In one embodiment, a coordinator 202 can enter both the CR 203 and the CFA 204 into the SCM System 205.

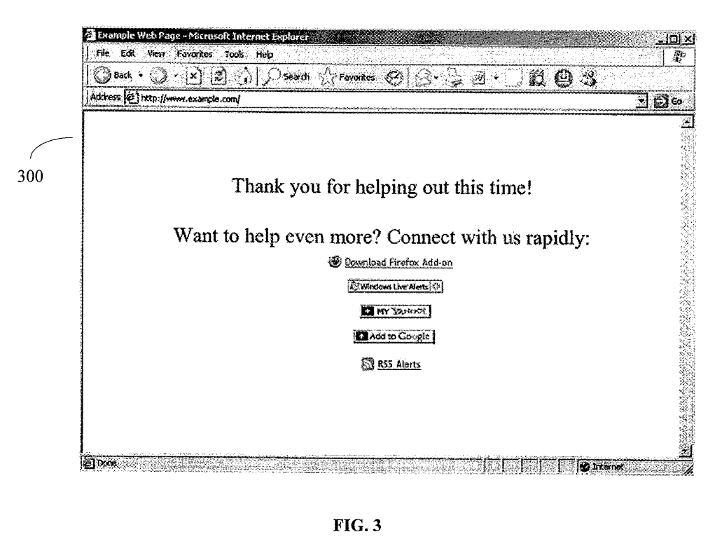

CR 203 can be a web page, an example of which is shown in FIG. 3, which includes a list of ways for a supporter to receive rapid communication from the coordination center. In the screenshot 300 of FIG. 3 the user is provided with the following ways to receive rapid communication: a specially created Firefoxextension, Windows Live Alert with MSN Messenger, MY Yahoo alerts, Google alerts or an RSS feed. In this example, when the user receives the CFA, the CFA may include an active link to the exemplary web site. In another embodiment, the CR may be an automated mechanism for automatically transmitting the CR response, such as an automated program or module executable on the processing platform running the recipients SCM program.

The CR may be in a text and/or image format for persuading the user to switch from the RCM technique to the SCM technique by providing RCM contact information to replace the SCM contact information. Additionally, the CR may be embedded in the CFA that is being transmitted to the user using the SCM technique, such as embedding a link to a secondary web page, embedding an active program or module or any other suitable technique recognized by one skilled in the art.

SCM System 205 sends a CFA (enhanced with a CR) 206 to each activist/user 103 via a SCM (e.g., email). Activists 103 perform the requested action 207 thru the SCM System 205 (e.g., by visiting the coordinating center's web site). Additionally, the user is provided with the CR, whereupon the user can agree to update the contact information from the SCM technique to the RCM technique. In this embodiment, the user responding to the CR request is referred to as a CR answer, which can take any number of suitable forms, dependent upon the embodiment of the CR request itself. For example, if the CR request is a web page, such as page 300 of FIG. 3, the CR answer may be html-encoded data that includes the updated contact information embedded therein. In another embodiment, the CR answer could be an email communication mirroring the communication technique through which the CFA was originally transmitted. For example, the CR answer 208 can be in the format of the user clicking on a web link in case the CR 203 is a web page.

In one embodiment, the SCM System 205 passes the CR answer 208 to CR Engine 201, which as discussed above regarding FIG. 1 is disposed within the coordination center 101. The CR Engine 201 passes the details (which includes the new contact information) of the users/activists to the RCM System 205. In one embodiment, the RCM System 205 is an external system, such as for example an instant messaging service, such as Yahoo! Messenger.

It is additionally important in the coordination center 101 that the user's contact information and status is reflected relative to the SCM technique, such that the users are not erroneously subjected to duplicative transmission of the CFAs via multiple communication mode techniques. The CR Engine 201 also adds the activist 103 to a suppression list 206, which is passed to SCM System 205. SCM System 205 thereby stops communicating with the activist 103 via SCM to avoid repetitive CFAs.

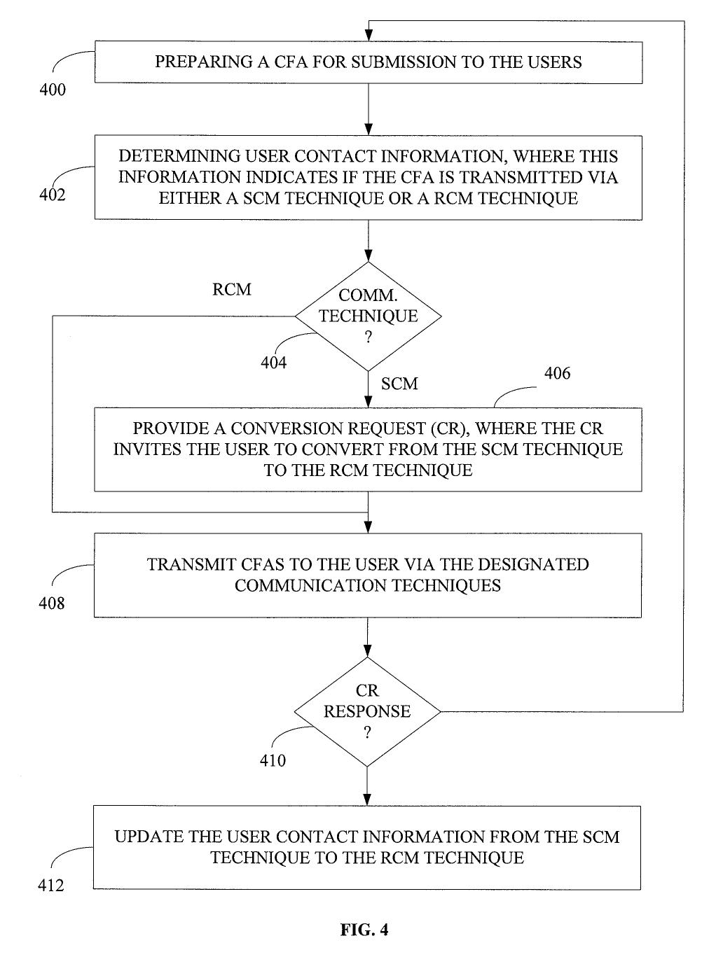

FIG. 4 illustrates a flowchart of the steps of one embodiment of a method for accelerating a response rate for action networks, where the action network provides calls for action (CFAs) to users. As described above, the method may be a computer-implemented method performed by a processing device, which may be in response to executable instructions stored on a computer-readable medium. A first step, step 400, is preparing a CFA for submission to the users. This step may be done using known CFA generation techniques, such as the CFA being generated by a coordinator.

A next step, step 402, is determining user contact information, where this information indicates if the CFA is transmitted via either a slow communication mode (SCM) technique or a rapid communication mode (RCM) technique. In one embodiment, the contact information may be stored in a separate database or storage location where the list of users/activists includes the contact information and the format of that contact information may indicate the communication mode technique. For example, if the contact information is an email address, this can be readily recognized as a SCM technique and if the contact information is an IM address, this can be recognized as an RCM technique.

A next step, step 404, is a decision step based on the corresponding communication technique. If the communication technique is via the SCM technique, the method continues to step 406, which includes providing a conversion request (CR), where the CR invites the user to convert from the SCM technique to the RCM technique. The providing of this conversion request may be consistent with the embodiments described above.

If in step 404, the communication technique is via the RCM technique or upon completion of step 406, the method continues to step 408, transmitting the CFAs to the users via designated communication mode techniques. Users having contact information for the SCM technique receive the CFA via this technique, where the CFA includes the CR and users having contact information for the RCM technique can more quickly receive the CFA for subsequent performance of the called for action.

In this embodiment, the users that receive the CR can thereby update the contact information, in other words answering the request to change the contact information. Thereby, in this methodology, a next step, step 410, is receiving CR responses from the users having received the CR. As described above, the form of the CR itself can determine the manner of receipt of these responses. The receipt of these responses allows for the tracking of the users who respond, as well as tracking the effectiveness of the CR technique. For example, various types of information can be determined, such as which users are quick to respond or another example is determining which RCM techniques may be preferred, such as users preferring an IM technique compared with an RSS feed, by way of example.

In the event no CR responses are received, the method reverts back to step 400, whereby additional CFAs can be generated. Although, when a CR response is received, the method further includes, updating the user contact information from the SCM technique to the RCM technique. As described above, updating this information insures additional transmissions are via the quicker RCM technique compared with the slower SCM technique. Additional embodiments may include the suppression list to protect against duplicative transmissions to the user across both transmission techniques.

An accelerated action network 100 can be implemented via one or more servers, with each server being one or more computers providing various shared resources with each other and to other system components. The shared resources include files for programs, web pages, databases and libraries; output devices, such as, printers, plotters, display monitors and facsimile machines; communications devices, such as modems and Internet access facilities; and other peripherals such as scanners, or the like. The communications devices can support wired or wireless communications, including satellite, terrestrial (fiber optic, copper, coaxial, and the like), radio, microwave, free-space optics, and/or any other form or method of transmission.

The servers hosting the coordination center 101 can be configured to support the standard Internet Protocol (IP) developed to govern communications over public and private Internet backbones. The protocol is defined in Internet Standard (STD) 5, Request for Comments (RFC) 791 (Internet Architecture Board). The server also supports transport protocols, such as, Transmission Control Protocol (TCP), User Datagram Protocol (UDP), Real Time Transport Protocol (RTP), or Resource Reservation Protocol (RSVP). The transport protocols support various types of data transmission standards, such as File Transfer Protocol (FTP), Hypertext Transfer Protocol (HTTP), Simple Network Management Protocol (SNMP), Network Time Protocol (NTP), or the like.

Communications network 102 provides a transmission medium for communicating among the system components. Communications network 110 includes a wired and/or wireless local area network (LAN), wide area network (WAN), or metropolitan area network (MAN), such as an organization's intranet, a local internet, the global-based Internet (including the World Wide Web (WWW)), an extranet, a virtual private network, licensed wireless telecommunications spectrum for digital cell (including CDMA, TDMA, GSM, EDGE, GPRS, CDMA2000, WCDMA FDD and/or TDD or TD-SCDMA technologies), or the like. Communications network 110 includes wired, wireless, or both transmission media, including satellite, terrestrial (e.g., fiber optic, copper, UTP, STP, coaxial, hybrid fiber-coaxial (HFC), or the like), radio, free-space optics, microwave, and/or any other form or method of transmission.

Other aspects would become apparent to those skilled in the relevant art(s) in view of the teachings of the present disclosure. FIGS. 1-3 are conceptual illustrations allowing an explanation of the present invention. It should be understood that various aspects of the embodiments of the present invention could be implemented in hardware, firmware, software, or a combination thereof. In such an embodiment, the various components and/or steps would be implemented in hardware, firmware, and/or software to perform the functions of the present invention. That is, the same piece of hardware, firmware, or module of software could perform one or more of the illustrated blocks (i.e., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by a processor to cause the processor to perform the functions of the invention as described herein. In this document, the terms “machine readable medium,” “computer program medium” and “computer usable medium” are used to generally refer to media such as a removable storage unit (e.g., a magnetic or optical disc, flash ROM, or the like), a hard disk, signals (i.e., electronic, electromagnetic, or optical signals), or the like.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the art.

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A computer-implemented method for accelerating a response rate for action networks, where the action network provides calls for action (CFAs) to users, the method comprising:
preparing a CFA for submission to the users;
determining user contact information, where this information indicates if the CFA is transmitted via either a slow communication mode (SCM) technique or a rapid communication mode (RCM) technique;
for each of the users having contract information indicating transmission via the SCM technique, providing a conversion request (CR), where the CR invites the user to convert from the SCM technique to the RCM technique;
transmitting the CFAs to the users via designated communication mode techniques;
receiving CR responses from the users having received the CR; and
upon receipt of the CR responses, updating the user contact information from the SCM technique to the RCM technique.

2. The method of claim 1, wherein the CR is in at least one of: a text format and an image format for persuading the user to switch to the RCM technique.

3. The method of claim 1, wherein the CR includes at least one of: an active link to transmit the CR response and an automation mechanism for automatically transmitting the CR response.

4. The method of claim 1 further comprising:
embedding the CR in the CFA being transmitted using the SCM technique.

5. The method of claim 1, wherein the CFA includes directions for visiting a designated website, the method further comprising:
embedding the CR in the web site; and
having a CR web page displayed relative to the user completing an action of the CFA.

6. The method of claim 1, wherein RCM includes at least one of: instant messaging, really simple syndication (RSS), short messaging service (SMS), and desktop alerts.

7. The method of claim 1 further comprising:
tracking users who convert from the SCM technique to the RCM technique.

8. A system for accelerating a response rate for action networks, where the action network provides calls for action (CFAs) to users, the system comprising:
a processing device, in response to executable instructions, operation to:
prepare a CFA for submission to the users;
determine user contact information, where this information indicates if the CFA is transmitted via either a slow communication mode (SCM) technique or a rapid communication mode (RCM) technique;
for each of the users having contract information indicating transmission via the SCM technique, provide a conversion request (CR), where the CR invites the user to convert from the SCM technique to the RCM technique;
transmit the CFAs to the users via designated communication mode techniques;
receive CR responses from the users having received the CR; and
upon receipt of the CR responses, update the user contact information from the SCM technique to the RCM technique.

9. The system of claim 8, wherein the CR is in at least one of: a text format and an image format for persuading the user to switch to the RCM technique.

10. The system of claim 8, wherein the CR includes at least one of: an active link to transmit the CR response and an automation mechanism for automatically transmitting the CR response.

11. The system of claim 8, wherein the processing device, in response to further executable instructions, is further operative to:
embed the CR in the CFA being transmitted using the SCM technique.

12. The system of claim 8, wherein the CFA includes directions for visiting a designated website, the processing device further operative to:
embed the CR in the web site; and
have a CR web page displayed relative to the user completing an action of the CFA.

13. The system of claim 8, wherein RCM includes at least one of: instant messaging, really simple syndication (RSS), short messaging service (SMS), and desktop alerts.

14. The system of claim 8, wherein the processing device, in response to further executable instructions, is further operative to:
track users who convert from the SCM technique to the RCM technique.

15. A computer readable medium storing program code that when executed by a programmable processor causes the processor to execute a method for accelerating a response rate for action networks, where the action network provides calls for action (CFAs) to users, the computer readable medium comprising:
programming code for preparing a CFA for submission to the users;
programming code for determining user contact information, where this information indicates if the CFA is transmitted via either a slow communication mode (SCM) technique or a rapid communication mode (RCM) technique;
for each of the users having contract information indicating transmission via the SCM technique, programming code for providing a conversion request (CR), where the CR invites the user to convert from the SCM technique to the RCM technique;
programming code for transmitting the CFAs to the users via designated communication mode techniques;
programming code for receiving CR responses from the users having received the CR; and
upon receipt of the CR responses, programming code for updating the user contact information from the SCM technique to the RCM technique.

16. The computer readable medium of claim 15, wherein the CR is in at least one of: a text format and an image format for persuading the user to switch to the RCM technique.

17. The computer readable medium of claim 15, wherein the CR includes at least one of: an active link to transmit the CR response and an automation mechanism for automatically transmitting the CR response.

18. The computer readable medium of claim 15 further comprising:
programming code for embedding the CR in the CFA being transmitted using the SCM technique.

19. The computer readable medium of claim 15, wherein the CFA includes directions for visiting a designated website, the computer readable medium further comprising:
programming code for embedding the CR in the web site; and
having a CR web page displayed relative to the user completing an action of the CFA.

20. The computer readable medium of claim 15, wherein RCM includes at least one of: instant messaging, really simple syndication (RSS), short messaging service (SMS), and desktop alerts.

21. The computer readable medium of claim 15 further comprising:
programming code for tracking users who convert from the SCM technique to the RCM technique.
